(19) United States
(12) Patent Application Publication
(10) Pub. No.: US 2024/0370078 A1
(43) Pub. Date: Nov. 7, 2024

(54) ROBUST PLATFORM LOW POWER MODE VIA EMBEDDED CONTROLLER-BASED HEALTH POLICY TO CORRECT ANOMALOUS COMPUTER IDLE CONDITIONS

(71) Applicant: Intel Corporation, Santa Clara, CA (US)

(72) Inventors: Jose Meza Arellano, Diamond Springs, CA (US); Mazen Gedeon, Hillsboro, OR (US)

(21) Appl. No.: 18/313,242

(22) Filed: May 5, 2023

(51) Int. Cl. G06F 1/3296

(52) U.S. Cl. CPC G06F 1/3296

(57) ABSTRACT

Embodiments herein relate to a computing device in which an embedded controller (EC) detects an anomalous low power state. When a processor in a chip package enters a low power state such as a deep idle state, the EC obtains information to verify whether activity of the processor is consistent with the low power state. The EC can communicate with the chip package via a serial peripheral interface to obtain counter data indicating an idle state residency of subsystems of the chip package, along with internal temperature data. The EC can also access data from an external temperature sensor and a battery fuel gauge. The EC determines whether the counter data, temperature and battery discharge rate are inconsistent with the processor entering the low power state. If there is an inconsistency, the EC can shutdown or restart the computing device.

### FIELD

The present application generally relates to the field of computing devices and more particularly to verifying whether a computing device is in a low power state.

### BACKGROUND

Computing devices such as desktop personal computers (PCs) and laptop computer or other mobile devices include many power-consuming components. These components include a central processing unit (CPU) or other processor, other internal integrated circuits, a display device and volatile memory. Reducing power consumption is an ongoing challenge. In one approach, when the user has not provided any input to the computer for a period of time, the computer may transition from an awake state to a sleep state in which the power supply circuit provides a reduced power output. This power output is sufficient to perform minimal functions such as refreshing the volatile memory to allow the computer to subsequently return to the wake state. However, various challenges remain in managing the power state of a computing device.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts a computing system 100 in which a chip package 102 communicates sleep state data to an embedded controller 150 via general purpose input-output (GPIO) pins 115 and 120, according to various embodiments.

FIG. 2 depicts a computing system 200 in which a chip package 202 communicates sleep state data to an embedded controller 250 via a serial peripheral interface (SPI) bus 126, according to various embodiments.

FIG. 3 depicts the embedded controller 250 of FIG. 2 and various peripherals with which it communicates, according to various embodiments.

FIG. 4A depicts a plot showing active/idle states of the subsystem 215 of FIG. 2. according to various embodiments.

FIG. 4B depicts a plot showing a count of the LPC counter 225 of FIG. 2, which is based on the active active/idle states of the subsystem 215 in a time period, according to various embodiments.

FIG. 5 depicts a sequence diagram consistent with the computing system 200 of FIG. 2, according to various embodiments.

FIG. 6 depicts a flowchart of an example process for use in the computing system 200 of FIG. 2, consistent with the sequence diagram of FIG. 5, according to various embodiments.

FIG. 7 illustrates an example of components that may be present in a computing system 650 for implementing the techniques (e.g., operations, processes, methods, and methodologies) described herein, according to various embodiments.

### DETAILED DESCRIPTION

As mentioned at the outset, various challenges remain in managing the power state of a computing device.

Computing devices can enter one or more reduced power states, also referred to as idle or sleep states, when the computing device is not in use or is only minimally in use. For example, a deep idle state, also known as S0ix, may be the lowest power consumption state in the platform. S0ix is a low-power state that processors can enter when they are not being used actively, but still need to remain responsive to incoming events. It is sometimes called “Modern Standby” or “Connected Standby” and is used in laptops, tablets, and other mobile devices. In the S0ix state, the CPU is still powered on, but its power consumption is greatly reduced. The CPU can quickly wake up in response to incoming events such as mouse movements, key presses, or network traffic, and resume normal operation. S0ix is different from traditional sleep states like S1, S2, and S3, which completely power down the CPU and require more time to wake up. S0ix is designed to provide a more responsive and power-efficient standby mode for modern mobile devices.

Adoption of the deep idle state feature has been successful in minimizing power consumption and therefore increasing battery life in modern mobile computers.

However, while it offers convenience to end users by extending battery life, it poses several challenges to original equipment manufacturers (OEMs) due to the complexity required to properly implement and tune their designs. One issue is that sometimes the mobile system fails to enter into the desired low power state completely. This can be caused by, e.g., OEM customizations or user modified settings. This failure, if not addressed, shortens the expected battery life.

For example, if the system fails to enter a low power state while stored in a closed briefcase, it can experience excessive heat since the CPU is not really suspended and only the display is off. This increased temperature degrades the system components faster than expected and diminishes the useful life of the CPU due to electromigration effects.

One possible solution to monitor, detect and correct an anomalous deep idle entry uses an embedded controller (EC) to monitor signals on certain pins on a chip package which indicate whether the C10 state or SLP-S0# state are active. The chip package can include one or more processors and one or more die. One example chip package is a single-chip package which includes a single die as a system-on-a-chip (SoC). Another example chip package is a multi-die chip package which includes multiple die, such as a die with a CPU and a companion die which acts as a bridge or controller for a variety of interfaces. One example of a companion die includes the Intel® Platform Controller Hub (PCH). The SoC may integrate the functions of the companion die onto a single die. The EC may include a microcontroller which runs firmware to handle various system tasks. The chip package and EC may be mounted on a common printed circuit board such as a motherboard, for example, in the computing device.

The C10 state or SLP-S0# state signals may be received at corresponding pins on the EC. The C10 state is a low-power idle state for the processor, where the processor is effectively turned off, and all of its caches are flushed. This state is typically entered when the processor is idle for an extended period and is not performing any tasks. To exit the C10 state, and return to an active state, the processor requires a wakeup event, such as an interrupt or a hardware event. The SLP_S0# state (Sleep S0 Low Power) is a platform-level low-power state, where power consumption is reduced by lowering the voltage and frequency of the processor and other system components. The platform can refer to one or more chips in a chip package, or to the overall computing device. The SLP_S0# state is typically used when the system is in a low-power idle state, but the user wants to quickly resume using the system without the need to restart it. The SLP_S0# signal indicates whether the system has entered the deepest S0ix state.

By monitoring these pins, which are general-purpose input-output (GPIO) pins, the EC can use heuristics to detect a failure to enter S0ix, for instance, by monitoring how long the processor has been in an idle state. However, this approach can be complex and inaccurate since the signals reflect every single transition that the CPU performs in and out of the S0ix state, and requires filtering and averaging. This also results in extra power consumption for the embedded controller, thus reducing the power savings of the deep idle state. In some cases, the CPU may not transition to the idle state, leading to an unexpected reduction in the battery charge level. The user may be faced with a failing battery when the user next attempts to use the computing device after it has supposedly entered a low power state and the computing device has been placed in a briefcase for travel, for example. The computing device may also become unexpectedly warm, resulting in a potential safety issue.

The solutions disclosed herein address the above and other issues. In one aspect, an embedded controller (EC) retrieves data in messages from a chip package over a serial peripheral interface (SPI) bus. One example is the Intel® enhanced SPI or eSPI. SPI is a synchronous serial communication interface specification used for short-distance communication, primarily in embedded systems. The data can indicate an idle state residency data for subsystems of the chip package and internal temperature data for a processor of the chip package. The idle state residency data can indicate a portion of a time period in which the various subsystems are an idle state. The subsystems can include, e.g., a Serial Advanced Technology Attachment (SATA) interface, an audio controller, a hard drive controller, a Universal Serial Bus (USB) controller, and a Peripheral Component Interconnect (PCI) express interface.

The EC can retrieve other data as well such as a temperature of the computing device external to the chip package and a battery charge level or discharge rate. The data retrieval can be triggered by receipt of information indicating the processor has entered a low power state. The EC can use the retrieved data to verify whether the activity of the processor is consistent with the low power state. Factors pointing away from a conclusion that the processor activity is inconsistent with the low power state include: relatively low idle residency times of the subsystems, relatively high processor and/or external temperatures or rates of change and relatively high battery discharge rates. Factors pointing toward a conclusion that the processor activity is consistent with the low power state include: relatively high idle residency times of the subsystems, relatively low processor and/or external temperatures or rates of change, and relatively low battery discharge rates. A relatively high value or a relatively low value can be a value which is above or below, respectively, a threshold.

If the processor activity is inconsistent with the low power state, an anomaly is detected. A corresponding action may be taken such as forcing the processor into a suspend, shutdown or restart.

The EC can therefore implement an intelligent system health policy to ensure a computing device does not enter an anomalous and potentially damaging state.

The solutions can provide a number of advantages. For example, the input/output (I/O) pins on the EC which would otherwise be allocated to monitoring the idle state (e.g., C10 state and SLP-S0# state) of a processor can be eliminated or used for other purposes. The solutions simplify OEM designs since they allow reuse of an existing interface. The solutions further take advantage of a low power bus for communication. The solutions do not require distributed logic across the operating system (OS), SoC firmware (FW) and the EC FW to provide a low-level health policy. The solutions detect an anomalous idle state with increased accuracy compared to other approaches.

The above and other advantages will be further apparent in view of the following discussion.

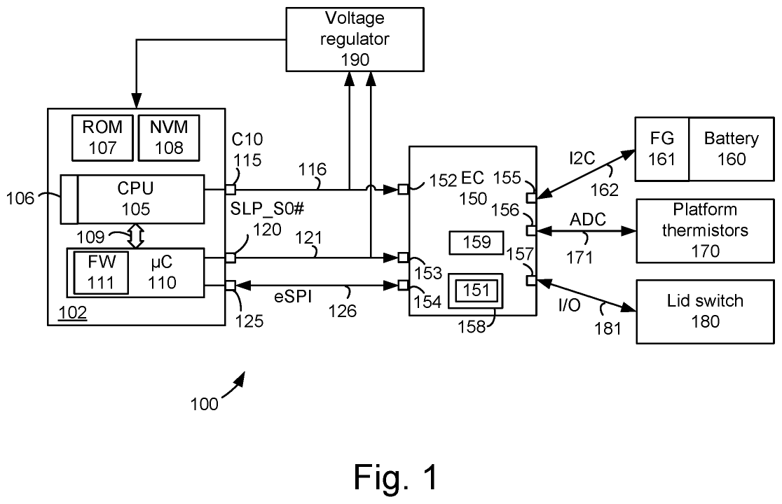

FIG. 1 depicts a computing system 100 in which a chip package 102 communicates sleep state data to an embedded controller 150 via general purpose input-output (GPIO) pins 115 and 120, according to various embodiments. The computing system can be part of a PC or mobile device, for example. The computing system includes a chip package 102 which can be single-die, such as in the case of a SoC, or multi-die, as mentioned. Multiple dies may be on a common substrate. The chip package includes a central processing unit (CPU) 105 or processor which communicates with a microprocessor (μC) 110 via a path 109. The CPU may include one or more cores and associated caches, and execute Basic Input-Output System (BIOS) code stored in a read-only memory (ROM) 107 and code stored in a non-volatile memory 108. The CPU may execute the BIOS code when powering up and subsequently execute the code in the NVM 108 to provide an operating system. One possible example of the microprocessor is the Intel® PCH. BIOS refers to, e.g., firmware used to provide runtime services for operating systems and programs and to perform hardware initialization during the booting process of a computing device.

A temperature sensor 106 may provide internal temperature data associated with the CPU and/or chip package 102. The temperature sensor may be located at the center of the CPU socket, in one approach. The temperature sensor may include an analog thermal diode, for example. In some cases, multiple sensors are provided at different locations, such as at different cores of the CPU or otherwise at different locations within the chip package. Multiple temperature readings can be averaged, in one approach.

The chip package 102 includes a number of I/O pins arranged at its periphery. These include pins 115, 120 and 125. In this example, pin 115 is used to transmit a signal indicating whether the C10 state (a low-power idle state for the processor) is set and pin 120 is used to transmit a signal indicating whether the SLP_S0# state (a platform-level low-power state) is set. The C10 signal is transmitted on a path 116 to a pin 152 of an EC and to a voltage regulator 190. The SLP_S0# signal is transmitted on a path 121 to a pin 153 of the EC and to the voltage regulator. The voltage regulator provides power to the chip package and can adjust its output to improve efficiency when an idle state exists as indicated by the C10 or SLP_S0# signals.

The pins 115 and 120 are examples of another pin or other pins which are to transmit a signal to a voltage regulator when the processor enters the low power state, wherein these pins are not coupled to the EC.

The pin 125 of the chip package is connected to an SPI bus 126 to exchange messages with the EC at a pin 154. The SPI bus in this example is an eSPI bus.

The EC 150 can include a microcontroller 159 which executes firmware 151 in a memory 158 to provide various functions including communicating with the chip package 102 and a number of peripherals. The peripherals can include a battery 160 with a fuel gauge (FG) 161 which indicates a charge level (capacity) of the battery. The fuel gauge can determine the charge based on the battery voltage and a charge flow, which can be determined using coulomb counting. The coulomb counting can involve integrating the currents flowing into and out of the battery cell. A small resistor can be connected in series with the anode of the battery to measure these currents with a high-resolution analog-to-digital converter (ADC). The EC may communicate with the fuel gauge via an Inter-Integrated Circuit (I2C) bus 162 and a pin 155, for example. An I2C bus is a synchronous serial communication bus.

The EC may also communicate with an external temperature sensor 170 via an ADC path 171 and a pin 156 to obtain temperature data. The temperature sensor 170 is external to the chip package 202 and may include one or more platform thermistors. A thermistor is a semiconductor type of resistor whose resistance is strongly dependent on temperature. In one approach, the sensor is attached to the surface or skin of the computing device. The temperature data may be in an analog form which is converted to a digital form for use by the EC.

The EC may also communicate with a lid switch 180 via an I/O path 181 and a pin 157 when the computing device is a laptop. The lid switch may include a magnet in the frame of the lid which interacts with a sensor in the bottom case when the lid is closed.

In this approach, the microprocessor 110 exposes two I/O pins 120 and 125 (for signals C10 and SLP_S0#, respectively) to allow the chip package platform to control the voltage regulator 190 so that the system will enter a more power efficient mode during the S0ix state of the CPU. These signals may also be connected to the EC for other power management related optimizations. These signals could also be used to detect anomalous S0ix entry in the field.

However, this approach reduces the number of pins which are available to the chip package and the EC. The physical pins could be replaced by a virtual wire, but if a SLP_S0# packet is transmitted over the SPI bus it would cause the chip package 102 to exit the low power state. Additionally, it requires an increased design effort in terms of hardware routing and firmware complexity. Other disadvantages include increased power consumption and relatively low accuracy in detecting a low power state.

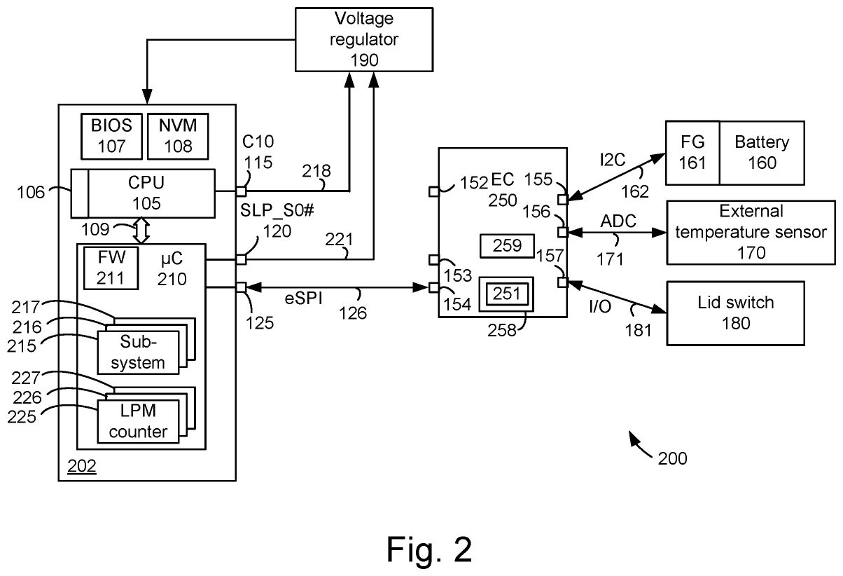

FIG. 2 depicts a computing system 200 in which a chip package 202 communicates sleep state data to an embedded controller 250 via a serial peripheral interface (SPI) bus 126, according to various embodiments. The SPI bus in this example is an eSPI bus. The EC 250 can include a microcontroller 259 which executes firmware 251 stored in a memory 258 to provide various functions including communicating with the chip package 102 and a number of peripherals via the pins the of EC.

The computing system includes a chip package 202 having a microcontroller 210 which executes firmware 211 to provide a plurality of subsystems 215, 216 and 217 and corresponding lower power mode (LPM) counters 225, 226 and 227, respectively. As mentioned, example subsystems include a SATA interface, an audio controller, a hard drive controller, a USB controller, and a PCI express interface.

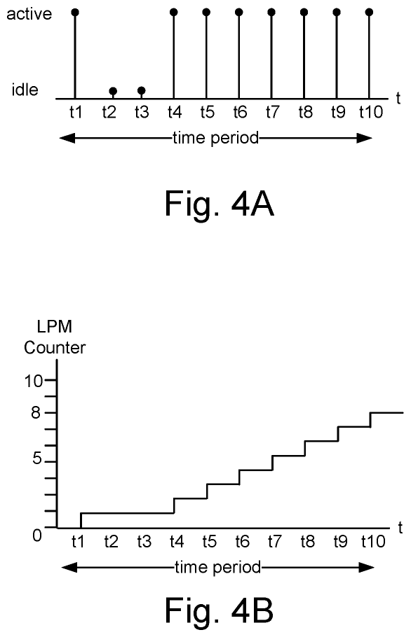

The LPM counters can be binary counters that count up, for instance, when the corresponding subsystem is in an idle or other low power state. The counters can advantageously be implemented in hardware so that they can be updated without FW intervention, in one possible approach. The counters can be used to detect idleness more accurately. The counters can generally measure resource utilization in the chip package. The counters can count up by one increment each clock cycle or other time interval in which the corresponding subsystem is active, e.g., in sending, receiving and/or processing data. A subsystem can transition back and forth between active and idle states. At the end of a time period, the count represents a portion of the time period in which the subsystem was active or idle, e.g., in an idle state residency. The counter can be reset and start again for a next time period. See also FIG. 4A and 4B.

In this scenario, the C10 signal is provided on the pin 115 and a path 218 to the voltage regulator 190 but not to the pin 152 of the EC 250. Similarly, the SLP_S0# signal is provided on the pin 120 and a path 221 to the voltage regulator but not to the pin 153 of the EC 250. This frees these pins 152 and 153 to be used for other purposes or to be removed to simplify the operation of, and reduce the size of, the EC. The microcontroller 210 can communicate data from the internal temperature sensor 106, CPU 105 and counters 225-227 to the EC via the pin 125 and SPI bus 126 for use by the EC in determining an anomalous low power condition. This is a condition in which the CPU has transitioned to a lower power state but the EC determines that the CPU activity is inconsistent with the low power state.

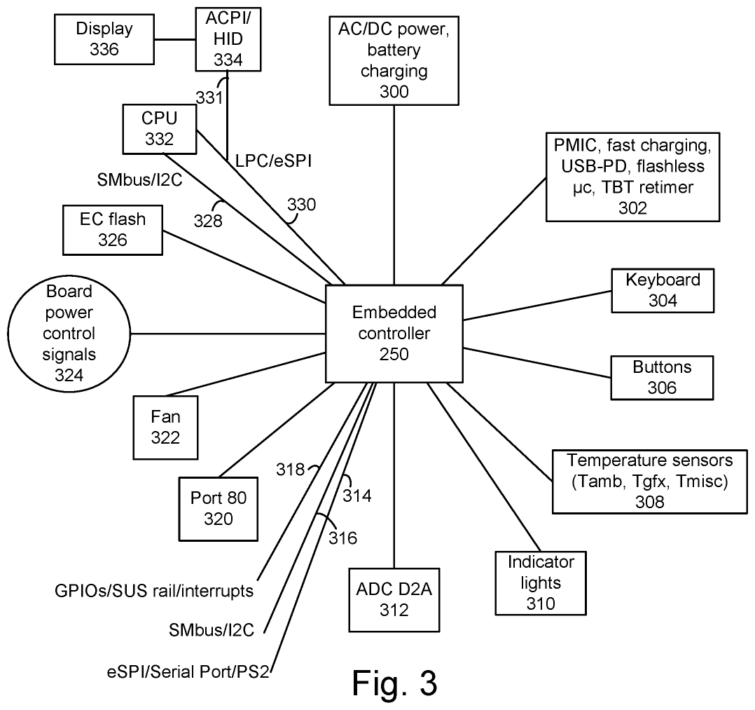

The EC 250 can communicate with peripherals such as depicted in FIG. 1. The peripherals depicted are relevant to verifying whether the low power state is inconsistent with the CPU activity. Generally, the EC 250 can communicate with a wide variety of peripherals such as depicted in FIG. 3.

During idle conditions, the EC can periodically monitor the CPU temperature at a relatively slow rate (e.g., once every 8 to 10 seconds) over the SPI bus via out-of-band transactions to allow a higher level of CPU low power residency.

If the chip package exposes the CPU residency statistics over a similar SPI out-of-band message, the EC can use this information to determine if CPU residency is not as expected.

By exposing information securely over the SPI, various advantages can be achieved. For example, an existing interface can be reused. Another advantage is that the messages can be sent over a low power bus. Additionally, increased accuracy is achieved in detecting an anomalous low power condition.

FIG. 3 depicts the embedded controller 250 of FIG. 2 and various peripherals with which it communicates, according to various embodiments. A peripheral 300 is for AC/DC power and battery charging. A peripheral 302 is for power management integrated circuit (PMIC), fast charging. USB-PD (power delivery), flashless (also known as ROMless) microcontroller and TBT retimer (a signal repeater for Intel® Thunderbolt™ M high-speed interface). A keyboard 304 is another peripheral. A mouse or other pointing device is another example peripheral. A peripheral 306 is for various buttons on the computing device, e.g., power button, volume control buttons, mute button, and controls for media programs. Temperature sensors 308 are another example of peripherals. These may measure ambient temperature (Tamb), a graphic processor temperature (Tgfx) and a temperature at another, miscellaneous location in the computing device (Tmisc). Indicator lights 310 are another example of peripherals.

A peripheral 312 represents an analog-to-digital converter (ADC) and a digital-to-analog (D2A) converter. A path 314 represents the eSPI, a path to a serial port and path to a PlayStation 2 (PS2) port or other gaming port. A path 316 represents a system management bus (SMbus) and an I2C bus. A path 318 represents GPIO pins, a suspend (SUS) power rail and interrupts. A peripheral 320 represents Port 80, the port number assigned to the internet communication protocol, Hypertext Transfer Protocol (HTTP). A fan 322 is another example peripheral. A peripheral 324 represents board power control signals. EC flash memory 326 is another example peripheral. The EC can further communicate with a CPU 332 via a path 328 using SMbus/I2C and via path 330 using a low pin count (LPC) interface or eSPI. The LPC interface is used to connect low-bandwidth devices to the CPU. eSPI replaces LPC. The path 330 and another path 331 allow the EC to communicate with a peripheral 334 for an Advanced Configuration and Power Interface (ACPI) and human interface device (HID) driver. The peripheral 334 in turn can communicate with a display 336.

FIG. 4A depicts a plot showing active/idle states of the subsystem 215 of FIG. 2. according to various embodiments. As mentioned, the subsystems of the chip package can transition back and forth between active and idle states, while a counter increments each clock cycle or other time interval in which the subsystem is active. Here, a time period has ten clock cycles or increment represents by t1 to t10. This is a time period in which a counter can increment, such as depicted in FIG. 4B. In FIG. 4A, the subsystem is active at time intervals t1 and t4 to t10.

FIG. 4B depicts a plot showing a count of the LPC counter 225 of FIG. 2, which is based on the active/idle states of the subsystem 215 in a time period, according to various embodiments. The time period corresponds to that of FIG. 4A. The LPM counter is initialized to zero at the start of the time period, and incremented by one unit for each interval in which the associated subsystem is in the active state. Accordingly, the counter increments from zero to one at t1, remains at one during t2 and t3, and increments by one for each of t4 to 10. The value of the counter at the end of the time period is eight in this example, indicating that the subsystem is active for 80% of the time period. The count can be determined for one or more time periods to obtain an idea of whether the CPU is in an idle/low power state. The count can be compared to a threshold where, when the count is below the threshold, this is consistent with a low power state and when the count is equal to or above the threshold, this is consistent with an active state/inconsistent with a low power state.

The counts of the different subsystems can be processed and analyzed within the chip package to determine if the CPU is in an idle/low power state. In this way, the chip package can provide data to the EC which reflects a higher level understanding of whether the CPU activity is consistent with a low power state. In one approach, the counts of the different subsystems are averaged and compared to a threshold to make the active/idle determination. In one approach, each count has an equal weight. In another approach, a count for a subsystem which is considered to be relatively highly probative of whether the CPU is in an idle/low power state can have a greater weight than a count for a subsystem which is not considered to be relatively highly probative of whether the CPU is in an idle/low power state. The time periods in which a count is obtained can be equal or different for different subsystems as well.

The count indicates an idle state residency of a subsystem, e.g., the portion of a time period in which the subsystem is in the idle state. Each count represents an idle time of a respective subsystem of one or more subsystems. Similar count data, also referred to as idle residency data, can be gathered for each of multiple subsystems.

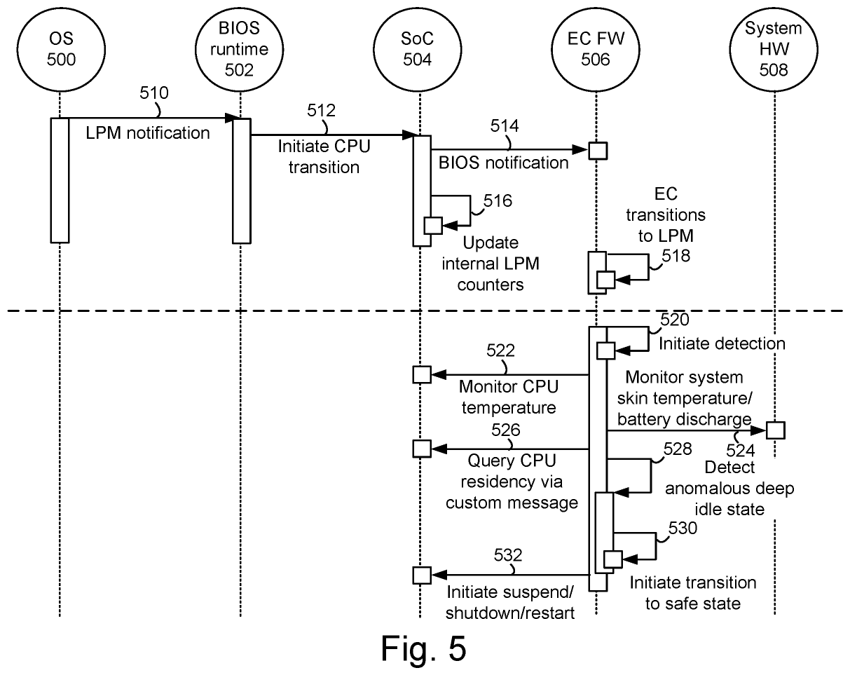

FIG. 5 depicts a sequence diagram consistent with the computing system 200 of FIG. 2, according to various embodiments. The diagram shows interactions between an EC and a chip package, and indicates how an EC can implement a health policy for a computing device based on custom residency queries made by the EC to the chip package via the SPI bus. In this example, the chip package comprises an SoC which handles the exchange of messages with the EC via the SPI bus. The sequence involves the operating system (OS) 500, the BIOS runtime 502, the SOC 504, the EC FW 506 and the system hardware (HW) 508, such as the external temperature sensor 170.

Initially, the OS enters a low power state. This can be triggered by various scenarios, including detecting that the user has not used the keyboard or other input device for a certain period of time or detecting that the lid of a laptop computer has been closed. At this time, the OS provides a low power mode (LPM) notification (arrow 510) to the BIOS runtime. In response, the BIOS runtime initiates a power state transition in the CPU (arrow 512), e.g., from an active state to a low power state, also referred to as a sleep or idle state. One example is the S0ix state, as discussed. The SoC 504, representing components such as the microcontroller 210, communicates the BIOS notification (arrow 514) to the EC FW 506 via the SPI bus 126. The SoC also updates its internal LPM counters (arrow 516). This can involve initializing the counters to begin counting in a time period to provide a count which indicates whether the associated subsystem is idle or active, as discussed.

When the EC receives the BIOS notification, it transitions itself to a low power mode (arrow 518). The EC also initiates a detection process (arrow 520) in which it monitors the subsystems using the counters, along with other factors such as temperature and battery discharge rate, to identify an anomalous low power condition/idle entry. For example, the EC can monitor the CPU temperature by communicating a request for temperature data (arrow 522) to the SoC via the SPI bus. In response to the request, the microcontroller 210 returns temperature data from the temperature sensor 106.

The EC can also obtain temperature data (arrow 524) from the system hardware, e.g., the external temperature sensor 170, which may provide an external or skin temperature. The EC can determine from the temperature sensors whether the system is overheating without reaching thermal shutdown. For example, the EC can compare the internal CPU temperature to the external temperature. If the internal temperature is greater than the external temperature by more than a threshold amount, this may indicate the activity of the CPU and/or chip package is inconsistent with the low power state. The EC can also compare a rate of change of the temperatures to a threshold to determine whether the temperature is increasing, steady or decreasing. An increasing or steady temperature may indicate the CPU activity is inconsistent with a low power state.

The EC can also obtain battery discharge data from the fuel gauge 161 (arrow 524) to determine whether the battery is discharging at a rate which is greater than a threshold. The threshold can represent an average discharge rate (e.g., a power consumption) for a deep idle state or other low power state, for example. If the battery is discharging at a rate which is greater than a threshold, this may indicate the CPU and/or chip package activity is activity is inconsistent with the low power state.

The EC can further query the CPU residency via a custom message (arrow 526). This can involve obtaining the counter values for the subsystems. Based on the obtained information, the EC detects whether there is an anomalous deep idle/low power state (arrow 528). Note that the order in which the EC obtains data as depicted in FIG. 5 is an example only, as other orders are possible. For example, the EC may obtain the counter value before obtaining the temperature data. Moreover, the EC can give equal weight or different weights to the different types of data. For example, the EC may give greater weight to the internal temperature than to the external temperature. The EC may give greater weight to the battery discharge rate or the counter values than to the temperature. Various options are possible.

In one approach, if the data is inconclusive as to whether there is an anomalous low power state, the EC will assume the low power state is not anomalous and continue monitoring. If an anomalous low power state is detected, the EC can initiate a transition of the computing device to a safe state (arrow 530). This can involve communicating a message to the SoC via the SPI to initiate a suspend, shutdown or restart of the processor/computing device (arrow 532).

For example, once the EC identifies an anomalous low power state, it can start transitioning the device to a failsafe mode, e.g., S4 (hibernation) or S5 (shutdown) via a request to the SoC over the SPI bus. In S4, the system appears to be off and power consumption is reduced to the lowest level. The system saves the contents of volatile memory to a hibernation file to preserve the system state. Some components remain powered so the computer can wake from input from the keyboard, LAN, or a USB device. S5 is a soft off state in which the system appears to be off.

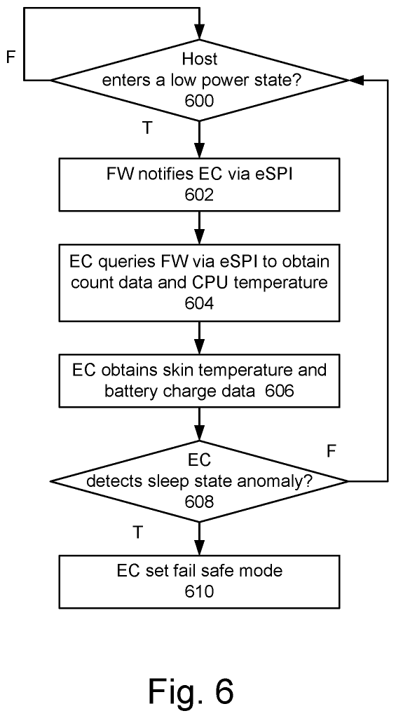

FIG. 6 depicts a flowchart of an example process for use in the computing system 200 of FIG. 2, consistent with the sequence diagram of FIG. 5, according to various embodiments. Operation 600 determines whether the host (e.g., CPU) enters a low power state such as the S0ix deep idle state. If the answer is false (F), the operation is repeated. If the answer is true (T), the FW of the host notifies the EC via the eSPI bus of the entrance to the low power state, at operation 602. In response, at operation 604, the EC queries the FW via the eSPI to obtain count data and CPU temperature data. Also, at operation 606, the EC obtains skin temperature and battery charge data. In one approach, the EC determines a discharge rate of the battery from multiple data samples of the charge level of the battery. At operation 608, the EC uses the data it has obtained to determine whether it detects a sleep state anomaly. If the answer is true, the EC sets a fail safe mode at operation 610. If the answer is false, the flow continues at operation 600.

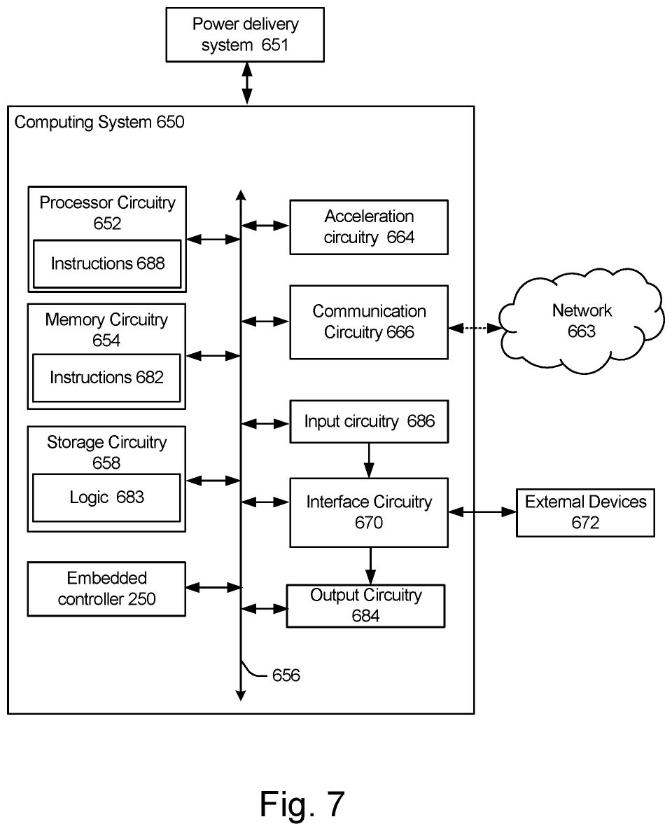

FIG. 7 illustrates an example of components that may be present in a computing system 650 for implementing the techniques (e.g., operations, processes, methods, and methodologies) described herein. The processor circuitry 652 may represent the chip package 202 of FIG. 2 while the embedded controller 250 is also depicted. The external devices 672 may represent the peripherals depicted in FIGS. 2 and 3.

The computing system 650 may be powered by a power delivery subsystem 651 and include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 650, or as components otherwise incorporated within a chassis of a larger system. For one embodiment, at least one processor 652 may be packaged together with computational logic 682 and configured to practice aspects of various example embodiments described herein to form a System in Package (SiP) or a System on Chip (SoC).

The system 650 includes processor circuitry in the form of one or more processors 652. The processor circuitry 652 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 652 may include one or more hardware accelerators (e.g., same or similar to acceleration circuitry 664), which may be microprocessors, programmable processing devices (e.g., FPGA, ASIC, etc.), or the like. The one or more accelerators may include, for example, computer vision and/or deep learning accelerators. In some implementations, the processor circuitry 652 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 652 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 652 may be coupled with or may include memory/storage and may be configured to execute instructions stored in the memory/storage to enable various applications or operating systems to run on the platform 650. The processors (or cores) 652 is configured to operate application software to provide a specific service to a user of the platform 650. In some embodiments, the processor(s) 652 may be a special-purpose processor(s)/controller(s) configured (or configurable) to operate according to the various embodiments herein.

As examples, the processor(s) 652 may include an Intel® Architecture Core™M based processor such as an i3, an i5, an i7, an i9 based processor; an Intel® microcontroller-based processor such as a Quark™M, an Atom™M, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.@ Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 652 may be a part of a system on a chip (SoC), System-in-Package (SiP), a multi-chip package (MCP), and/or the like, in which the processor(s) 652 and other components are formed into a single integrated circuit, or a single package, such as the Edison™ or Galileo™ SoC boards from Intel® Corporation. Other examples of the processor(s) 652 are mentioned elsewhere in the present disclosure.

The system 650 may include or be coupled to acceleration circuitry 664, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 664 may comprise logic blocks or logic fabric and other interconnected resources that may be programmed (configured) to perform various functions, such as the procedures, methods, functions, etc. of the various embodiments discussed herein. In such implementations, the acceleration circuitry 664 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 652 and/or acceleration circuitry 664 may include hardware elements specifically tailored for machine learning and/or artificial intelligence (AI) functionality. In these implementations, the processor circuitry 652 and/or acceleration circuitry 664 may be, or may include, an AI engine chip that can run many different kinds of Al instruction sets once loaded with the appropriate weightings and training code. Additionally or alternatively, the processor circuitry 652 and/or acceleration circuitry 664 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 652 and/or acceleration circuitry 664 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple@ All or A12 Bionic SoC, the Neural Processing Unit (NPU) within the HiSilicon Kirin 970 provided by Huawei®, and/or the like. In some hardware-based implementations, individual subsystems of system 650 may be operated by the respective Al accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 650 also includes system memory 654. Any number of memory devices may be used to provide for a given amount of system memory. As examples, the memory 654 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 654 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 654 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 658 provides persistent storage of information such as data, applications, operating systems and so forth. In an example, the storage 658 may be implemented via a solid-state disk drive (SSDD) and/or high-speed electrically erasable memory (commonly referred to as “flash memory”). Other devices that may be used for the storage 658 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 654 and/or storage circuitry 658 may also incorporate three-dimensional (3D) cross-point (XPOINT) memories from Intel® and Micron®.

The memory circuitry 654 and/or storage circuitry 658 is/are configured to store computational logic 683 in the form of software, firmware, microcode, or hardware-level instructions to implement the techniques described herein. The computational logic 683 may be employed to store working copies and/or permanent copies of programming instructions, or data to create the programming instructions, for the operation of various components of system 650 (e.g., drivers, libraries, application programming interfaces (APIs), etc.), an operating system of system 650, one or more applications, and/or for carrying out the embodiments discussed herein. The computational logic 683 may be stored or loaded into memory circuitry 654 as instructions 682, or data to create the instructions 682, which are then accessed for execution by the processor circuitry 652 to carry out the functions described herein. The processor circuitry 652 and/or the acceleration circuitry 664 accesses the memory circuitry 654 and/or the storage circuitry 658 over the interconnect (IX) 656. The instructions 682 direct the processor circuitry 652 to perform a specific sequence or flow of actions, for example, as described with respect to flowchart(s) and block diagram(s) of operations and functionality depicted previously. The various elements may be implemented by assembler instructions supported by processor circuitry 652 or high-level languages that may be compiled into instructions 688, or data to create the instructions 688, to be executed by the processor circuitry 652. The permanent copy of the programming instructions may be placed into persistent storage devices of storage circuitry 658 in the factory or in the field through, for example, a distribution medium (not shown), through a communication interface (e.g., from a distribution server (not shown)), over-the-air (OTA), or any combination thereof.

The IX 656 couples the processor 652 to communication circuitry 666 for communications with other devices, such as a remote server (not shown) and the like. The communication circuitry 666 is a hardware element, or collection of hardware elements, used to communicate over one or more networks 663 and/or with other devices. In one example, communication circuitry 666 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 666 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 656 also couples the processor 652 to interface circuitry 670 that is used to connect system 650 with one or more external devices 672. The external devices 672 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 650, which are referred to as input circuitry 686 and output circuitry 684. The input circuitry 686 and output circuitry 684 include one or more user interfaces designed to enable user interaction with the platform 650 and/or peripheral component interfaces designed to enable peripheral component interaction with the platform 650. Input circuitry 686 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 684 may be included to show information or otherwise convey information, such as sensor readings, actuator position(s), or other like information. Data and/or graphics may be displayed on one or more user interface components of the output circuitry 684. Output circuitry 684 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 650. The output circuitry 684 may also include speakers and/or other audio emitting devices, printer(s), and/or the like. Additionally or alternatively, sensor(s) may be used as the input circuitry 684 (e.g., an image capture device, motion capture device, or the like) and one or more actuators may be used as the output device circuitry 684 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 650 may communicate over the IX 656. The IX 656 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 656 may be a proprietary bus, for example, used in a SoC based system.

The number, capability, and/or capacity of the elements of system 650 may vary, depending on whether computing system 650 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 650 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a chip package comprising a processor or other circuit or computing device and one or more counters, wherein each counter of the one or more counters is to provide a count which represents an idle time of a respective subsystem of one or more subsystems; an embedded controller (EC); and a serial peripheral interface (SPI) bus coupled to the chip package and the embedded controller, wherein when the processor enters a low power state, the EC is to obtain the count from each counter of the one or more counters via the SPI bus, and determine whether activity of the processor is inconsistent with the low power state based on the count from each counter of the one or more counters.

Example 2 includes the apparatus of claim 1, wherein: the chip package is to transmit a C10 signal and an SLP_S0# signal to a voltage regulator; the C10 signal indicates whether the processor is in the low power state; the SLP_S0# signal indicates whether a platform of the processor is in the low power state; and the EC is to determine whether the activity of the processor is inconsistent with the low power state without accessing the C10 signal or the SLP_S0# signal.

Example 3 includes the apparatus of Example 1 or 2, wherein the one or more subsystems comprise at least one of a Serial Advanced Technology Attachment (SATA) interface, an audio controller, a hard drive controller, a Universal Serial Bus (USB) controller, or a Peripheral Component Interconnect (PCI) express interface.

Example 4 includes the apparatus of any one of Examples 1 to 3, wherein when the EC determines that the activity of the processor is inconsistent with the low power state, the EC is to initiate a fail safe mode for the apparatus.

Example 5 includes the apparatus of Example 4, wherein the fail safe mode comprises a suspend, shutdown or restart of the apparatus.

Example 6 includes the apparatus of any one of Examples 1 to 5, wherein the low power state comprises a deep idle state.

Example 7 includes the apparatus of any one of Examples 1 to 6, wherein when the processor enters the low power state, the EC is to obtain internal temperature data of the processor via the SPI bus and determine whether the activity of the processor is inconsistent with the low power state based on the internal temperature data.

Example 8 includes the apparatus of any one of Examples 1 to 7, wherein when the processor enters the low power state, the EC is to obtain external temperature data, external to the chip package, and determine whether the activity of the processor is inconsistent with the low power state based on the external temperature data.

Example 9 includes the apparatus of any one of Examples 1 to 8, wherein the processor is powered by a battery, and when the processor enters the low power state, the EC is to determine a discharge rate of the battery, and determine whether the activity of the processor is inconsistent with the low power state based on whether the discharge rate of the battery exceeds a threshold.

Example 10 includes the apparatus of any one of Examples 1 to 9, wherein when the processor enters the low power state, the EC receives a notification from a basic input output system (BIOS) of the processor and initiates the obtaining of the count from each counter of the one or more counters in response to the notification.

Example 11 includes an apparatus, comprising: a processor or other circuit or computing device; one or more counters, wherein each counter of the one or more counters is to provide a count which represents a portion of a time period in which a respective subsystem of one or more subsystems is idle; and a pin coupled to a serial peripheral interface (SPI) bus to communicate with an embedded controller (EC), wherein the apparatus is to notify the EC via the SPI bus when the processor enters a low power state, and to transmit the count from each counter of the one or more counters to the EC via the SPI bus in response to a request from the EC via the SPI bus.

Example 12 includes the apparatus of Example 11, wherein the processor is on a system-on-a-chip (SoC), and the SoC is to notify the EC via the SPI bus when the processor enters the low power state, and to transmit the count from each counter of the one or more counters to the EC via the SPI bus in response to the request from the EC via the SPI bus.

Example 13 includes the apparatus of Example 11 or 12, further comprising another pin to transmit a signal to a voltage regulator when the processor enters the low power state, wherein the another pin is not coupled to the EC.

Example 14 includes the apparatus of any one of Examples 11 to 13, further comprising other pins to transmit a C10 signal and an SLP_S0# signal to a voltage regulator, wherein the C10 signal indicates whether the processor is in the low power state, the SLP_S0# signal indicates whether a platform of the processor is in the low power state, and the other pins are not coupled to the EC.

Example 15 includes the apparatus of any one of Examples 11 to 14, further comprising a temperature sensor for the processor, wherein the apparatus is to transmit temperature data from the temperature sensor to the EC via the SPI bus in response to a request for the temperature data from the EC via the SPI bus.

Example 16 includes the apparatus of any one of Examples 11 to 15, wherein the apparatus comprises a chip package.

Example 17 includes an embedded controller (EC), comprising: a first pin coupled to a serial peripheral interface (SPI) bus to receive a message from a chip package when a processor or other circuit or computing device of the chip package enters a low power state; a second pin coupled to a fuel gauge of a battery; and a microcontroller coupled to the first pin and the second pin, wherein the microcontroller, in response to the message, is to determine a discharge rate of the battery and determine based on the discharge rate of the battery whether the processor is in an anomalous low power state.

Example 18 includes the EC of Example 17, wherein in response to the message, the microcontroller is to request idle state residency data from the chip package via the SPI bus for one or more subsystems, and to determine based on the idle state residency data whether the processor is in the anomalous low power state.

Example 19 includes the EC of Example 17 or 18, wherein in response to the message, the microcontroller is to request internal temperature data from the chip package via the SPI bus, and to determine based on the internal temperature data whether the processor is in the anomalous low power state.

Example 20 includes the EC of any one of Examples 17 to 19, wherein the microcontroller is to transmit a message to the chip package via the SPI bus to suspend, restart or shutdown the processor when the processor is in the anomalous low power state.

Example 21 includes a method, comprising: when a processor enters a low power state, obtaining, at an embedded controller, a count from each counter of one or more counters via a serial peripheral interface (SPI) bus, wherein each counter of the one or more counters is to provide a count which represents an idle time of a respective subsystem of one or more subsystems, and determining whether activity of the processor is inconsistent with the low power state based on the count from each counter of the one or more counters.

Example 22 includes the method of Example 21, further comprising: in response to determining that the activity of the processor is inconsistent with the low power state, initiating a fail safe mode comprising a suspend, shutdown or restart.

Example 23 includes the method of Example 21 or 22, further comprising: when the processor enters the low power state, obtaining internal temperature data of the processor via the SPI bus for use in the determining whether the activity of the processor is inconsistent with the low power state.

Example 24 includes the method of any one of Examples 21 to 23, further comprising: when the processor enters the low power state, obtaining external temperature data, external to the processor, for use in the determining whether the activity of the processor is inconsistent with the low power state.

Example 25 includes an apparatus comprising means to perform the method of any one of Examples 21 to 24.

Example 26 includes non-transitory machine-readable storage including machine-readable instructions that, when executed, cause a processor or other circuit or computing device to implement the method of any one of Examples 21 to 24.

Example 27 includes a computer program comprising instructions which, when the program is executed by a computer, cause the computer to carry out the method of any one of Examples 21 to 24.

Example 28 includes a method performed by a chip package which includes a processor and one or more counters, the method comprising: at each counter of the one or more counters, providing a count which represents a portion of a time period in which a respective subsystem of one or more subsystems is idle; notifying an embedded controller (EC) via a serial peripheral interface (SPI) bus when the processor enters a low power state; receiving a request from the EC via the SPI bus pursuant to the notification; and in response to the request, transmitting the count from each counter of the one or more counters to the EC via the SPI bus.

Example 29 includes the method of Example 28, wherein the chip package further comprises a temperature sensor for the processor, and the method further comprises: transmitting temperature data from the temperature sensor to the EC via the SPI bus in response to a request for the temperature data from the EC received via the SPI bus.

Example 30 includes an apparatus comprising means to perform the method of Example 28 or 29.

Example 31 includes non-transitory machine-readable storage including machine-readable instructions that, when executed, cause a processor or other circuit or computing device to implement the method of Example 28 or 29.

Example 32 includes a computer program comprising instructions which, when the program is executed by a computer, cause the computer to carry out the method of Example 28 or 29.

Example 33 includes a method performed by an embedded controller (EC), comprising: receiving, via a serial peripheral interface (SPI) bus, a message from a chip package when a processor of the chip package enters a low power state; in response to the message, determining a discharge rate of a battery which powers the chip package; and determining based on the discharge rate of the battery whether the processor is in an anomalous low power state.

Example 34 includes the method of Example 33, further comprising: in response to the message, requesting idle state residency data from the chip package via the SPI bus for one or more subsystems, and to determining based on the idle state residency data whether the processor is in the anomalous low power state.

Example 35 includes the method of Example 33 or 34, further comprising: in response to the message, requesting internal temperature data from the chip package via the SPI bus, and determining based on the internal temperature data whether the processor is in the anomalous low power state.

Example 36 includes the method of any one of Examples 33 to 35, further comprising: transmitting a message to the chip package via the SPI bus to suspend, restart or shutdown the processor when the processor is in the anomalous low power state.

Example 37 includes an apparatus comprising means to perform the method of any one of Examples 33 to 36.

Example 38 includes non-transitory machine-readable storage including machine-readable instructions that, when executed, cause a processor or other circuit or computing device to implement the method of any one of Examples 33 to 36.

Example 39 includes a computer program comprising instructions which, when the program is executed by a computer, cause the computer to carry out the method of any one of Examples 33 to 36.

In the present detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may.” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a chip package comprising a processor and one or more counters, wherein each counter of the one or more counters is to provide a count which represents an idle time of a respective subsystem of one or more subsystems;
an embedded controller (EC); and
a serial peripheral interface (SPI) bus coupled to the chip package and the embedded controller, wherein when the processor enters a low power state, the EC is to obtain the count from each counter of the one or more counters via the SPI bus, and determine whether activity of the processor is inconsistent with the low power state based on the count from each counter of the one or more counters.

2. The apparatus of claim 1, wherein:
the chip package is to transmit a C10 signal and an SLP_S0# signal to a voltage regulator;
the C10 signal indicates whether the processor is in the low power state;
the SLP_S0# signal indicates whether a platform of the processor is in the low power state; and
the EC is to determine whether the activity of the processor is inconsistent with the low power state without accessing the C10 signal or the SLP_S0# signal.

3. The apparatus of claim 1, wherein the one or more subsystems comprise at least one of a Serial Advanced Technology Attachment (SATA) interface, an audio controller, a hard drive controller, a Universal Serial Bus (USB) controller, or a Peripheral Component Interconnect (PCI) express interface.

4. The apparatus of claim 1, wherein when the EC determines that the activity of the processor is inconsistent with the low power state, the EC is to initiate a fail safe mode for the apparatus.

5. The apparatus of claim 4, wherein the fail safe mode comprises a suspend, shutdown or restart of the apparatus.

6. The apparatus of claim 1, wherein the low power state comprises a deep idle state.

7. The apparatus of claim 1, wherein when the processor enters the low power state, the EC is to obtain internal temperature data of the processor via the SPI bus and determine whether the activity of the processor is inconsistent with the low power state based on the internal temperature data.

8. The apparatus of claim 1, wherein when the processor enters the low power state, the EC is to obtain external temperature data, external to the chip package, and determine whether the activity of the processor is inconsistent with the low power state based on the external temperature data.

9. The apparatus of claim 1, wherein the processor is powered by a battery, and when the processor enters the low power state, the EC is to determine a discharge rate of the battery, and determine whether the activity of the processor is inconsistent with the low power state based on whether the discharge rate of the battery exceeds a threshold.

10. The apparatus of claim 1, wherein when the processor enters the low power state, the EC receives a notification from a basic input output system (BIOS) of the processor and initiates the obtaining of the count from each counter of the one or more counters in response to the notification.

11. An apparatus, comprising:
a processor;
one or more counters, wherein each counter of the one or more counters is to provide a count which represents a portion of a time period in which a respective subsystem of one or more subsystems is idle; and
a pin coupled to a serial peripheral interface (SPI) bus to communicate with an embedded controller (EC), wherein the apparatus is to notify the EC via the SPI bus when the processor enters a low power state, and to transmit the count from each counter of the one or more counters to the EC via the SPI bus in response to a request from the EC via the SPI bus.

12. The apparatus of claim 11, wherein the processor is on a system-on-a-chip (SoC), and the SoC is to notify the EC via the SPI bus when the processor enters the low power state, and to transmit the count from each counter of the one or more counters to the EC via the SPI bus in response to the request from the EC via the SPI bus.

13. The apparatus of claim 11, further comprising another pin to transmit a signal to a voltage regulator when the processor enters the low power state, wherein the another pin is not coupled to the EC.

14. The apparatus of claim 11, further comprising other pins to transmit a C10 signal and an SLP_S0# signal to a voltage regulator, wherein the C10 signal indicates whether the processor is in the low power state, the SLP_S0# signal indicates whether a platform of the processor is in the low power state, and the other pins are not coupled to the EC.

15. The apparatus of claim 11, further comprising a temperature sensor for the processor, wherein the apparatus is to transmit temperature data from the temperature sensor to the EC via the SPI bus in response to a request for the temperature data from the EC via the SPI bus.

16. The apparatus of claim 11, wherein the apparatus comprises a chip package.

17. An embedded controller (EC), comprising:
a first pin coupled to a serial peripheral interface (SPI) bus to receive a message from a chip package when a processor of the chip package enters a low power state; and
a second pin coupled to a fuel gauge of a battery; and
a microcontroller coupled to the first pin and the second pin, wherein the microcontroller, in response to the message, is to determine a discharge rate of the battery and determine based on the discharge rate of the battery whether the processor is in an anomalous low power state.

18. The EC of claim 17, wherein in response to the message, the microcontroller is to request idle state residency data from the chip package via the SPI bus for one or more subsystems, and to determine based on the idle state residency data whether the processor is in the anomalous low power state.

19. The EC of claim 17, wherein in response to the message, the microcontroller is to request internal temperature data from the chip package via the SPI bus, and to determine based on the internal temperature data whether the processor is in the anomalous low power state.

20. The EC of claim 17, wherein the microcontroller is to transmit a message to the chip package via the SPI bus to suspend, restart or shutdown the processor when the processor is in the anomalous low power state.
